(19) United States
(12) Patent Application Publication
(10) Pub. No.: US 2025/0176494 A1
(43) Pub. Date: Jun. 5, 2025

(54) SHOULDER-MOUNTED PLATFORM FOR SHOULDER CATS

(71) Applicant: Michael Marshall, Montreal (CA)

(72) Inventor: Michael Marshall, Montreal (CA)

(21) Appl. No.: 19/013,566

(22) Filed: Jan. 8, 2025

(51) Int. Cl. A01K 1/02

(52) U.S. Cl. CPC A01K 1/029

(57) ABSTRACT

The invention is a shoulder-mounted platform for shoulder cats that sits atop a wearer's shoulder providing a platform upon which a cat may position itself oriented with its body perpendicular to the wearer's shoulder.

### TECHNICAL FIELD

The invention is a system for supporting a cat that is situated on a person's shoulder.

### BACKGROUND OF INVENTION

Scientists believe that the special relationship between humans and house cats emerged roughly 10,000 years ago. Despite millennia of domestication, many cat behaviors are still governed by instinct. Animal experts posit, for example, that cats that like to sit on a human's shoulder, commonly referred to as shoulder cats, do so to obtain a higher vantage point and to feel safe. When something unexpected happens causing a shoulder cat to begin slipping off a shoulder, its tendency is to claw in in order to stabilize itself. That may result in torn clothing and seriously scratched skin.

Devices have been invented that act as a pet carrier and are worn around the back or the front of the wearer. Some are designed to ride high up, between the shoulders, placing the pet behind the wearer.

Cats, however, when riding on a shoulder, seem to prefer to orient themselves essentially at right angles to the shoulder, facing forward. Owners of shoulder cats who take them on hikes observe that their cats prefer to face forward so they can see in the direction of movement.

A device that acts as a pet carrier and is oriented parallel to the shoulders neglects the cat's instinctive preferred orientation.

### BRIEF DESCRIPTION OF THE INVENTION

The invention is a shoulder-mounted platform that sits essentially at right angles to the portion of the shoulder that extends from neck to shoulder joint.

The invention comprises two portions, one in front of the wearer and one behind the wearer, connected by a strap and a harness for securing it to the wearer. Each portion comprises an upper plate structure, an outer plate structure, and an inner plate structure. The upper plates are affixed to the outer plates, which are affixed to the inner plates. The inner plates are attached to the harness.

The connecting strap is an adjustable hook-and-loop material strap that adjusts the displacement between the front and rear portions related to the wearer's shoulder dimensions.

The outer plate is a hinged structure with a portion that is affixed to the inner plate, and a portion that is affixed to the upper plate.

The upper plate, when affixed to the outer plate may be extended horizontally, and rotated horizontally. The portion of the outer plate that is affixed to the inner plate may be extended, right or left, laterally, and rotated in a vertical plane. These adjustments enable the invention to be fitted to a variety of shoulder dimensions.

The harness comprises two horizontally oriented portions that surround the upper torso, and portions that connect the inner plates to the horizontally oriented harness portion. These allow the invention platform to be mounted on either shoulder and to be adjusted to fit the wearer.

### BRIEF DESCRIPTION OF DRAWINGS

FIG. 1 illustrates the invention worn by a wearer and a cat in place on top.

FIG. 2 illustrates the same FIG. 1 from a left-rear perspective.

FIG. 3 illustrates the invention deployed on a wearer's left shoulder.

FIG. 4 illustrates an embodiment of the invention showing its structural elements.

FIG. 5 illustrates a clamping fixture used to adjust the position of an upper plate.

FIG. 6 illustrates the orientation adjustability of embodiment of FIG. 4's structural elements.

FIG. 7 illustrates the apertures in an embodiment of the upper plate allowing a cat to firmly grasp the upper plate for positional stability.

FIG. 8 illustrates the harness buckle and adjustment elements.

### DETAILED DESCRIPTION OF INVENTION

The invention is a shoulder-mounted platform upon which a cat may position itself when a wearer is sitting, standing, or walking.

The invention enables the wearer to deploy the platform on either shoulder, and has structural features that enable adjustments to accommodate a wearer's size for optimal fit, comfort, and support.

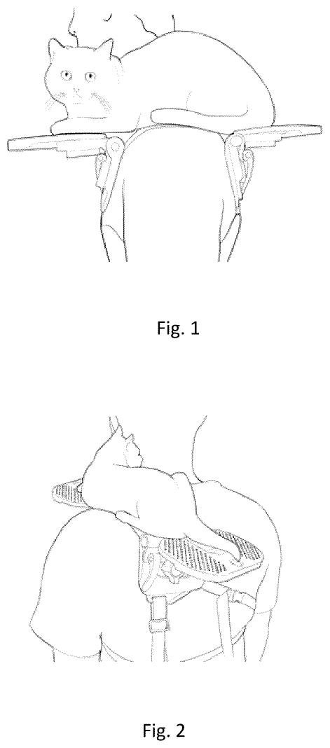

As shown in FIG. 1, the invention platform rests atop a wearer's shoulder and is oriented such that a cat's body is essentially perpendicular to the wearer's shoulder.

As shown in FIG. 2, the platform of FIG. 1 is shown from a rear, left-side perspective showing more detail of the harness structure that holds the invention platform in place.

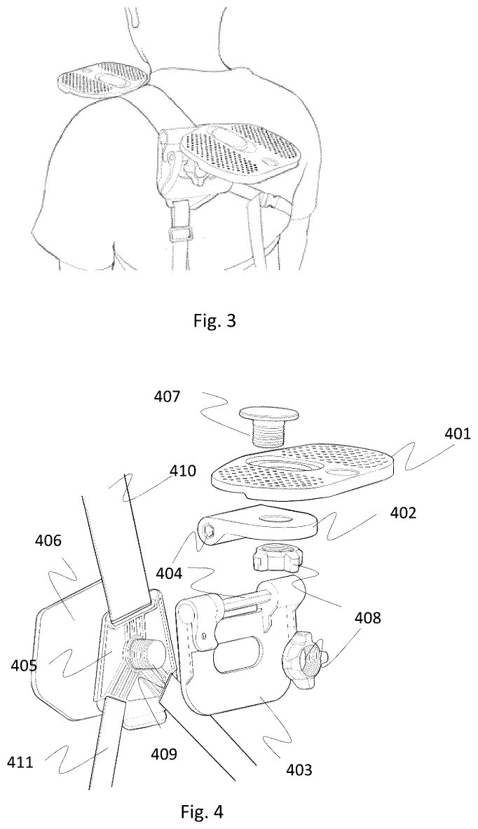

As shown in FIG. 3, the front and back portions of the platform are joined to one another by a strap which sits atop the wearer's shoulder.

FIG. 4 shows the structural elements of the invention platform focusing on one of the two portions. An upper plate, 401, sits atop the horizontal portion of an outer plate structure, 402, and is held in place by a fixture, 407 and 408. The outer-plate portion to which the upper-plate is affixed is hinged (404) to the vertical portion of the outer plate, 403. The outer-plate portion, 403, is held in place by a fixture, 409 and 408, affixing it to the inner plate, 405, and its padded structure, 406. A strapping structure (410) has one end connected to the inner plate (as shown) and its opposite end to the other inner plate (not shown). The inner plate is attached to one portion of the harness, 411, as shown. The other inner plate is connected to another portion of the harness structure (not shown).

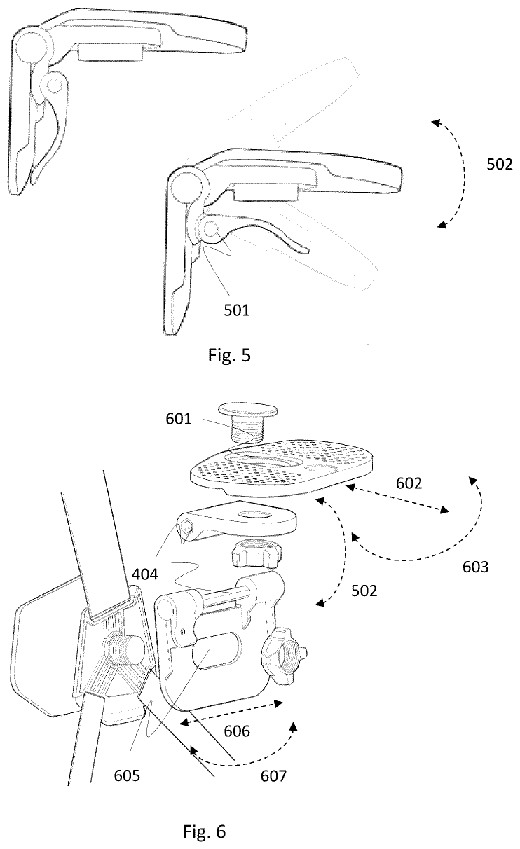

As shown in FIG. 5, at least one outer-plate has a clamping fixture, 501, that when unclamped allows the upper plate to rotate up or down as shown (502).

As shown in FIG. 6, the upper plates have an elongated aperture, 601, that allows the upper plate to be extended horizontally (602) and/or rotated (603). The hinging structure that joins the two portions of the outer plate (404) allows the upper plate to be rotated in a vertical plane (502). The outer plate has an elongated aperture (605) that enables the outer plate to be moved laterally with respect to the inner plate (606) and/or rotated in a vertical plane (607). These fixture-based adjustments enable the invention platform to be fitted to a variety of shoulder widths and slopes.

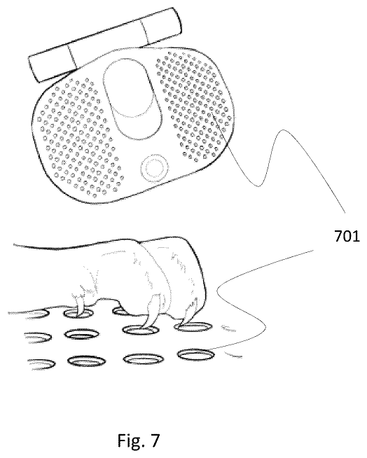

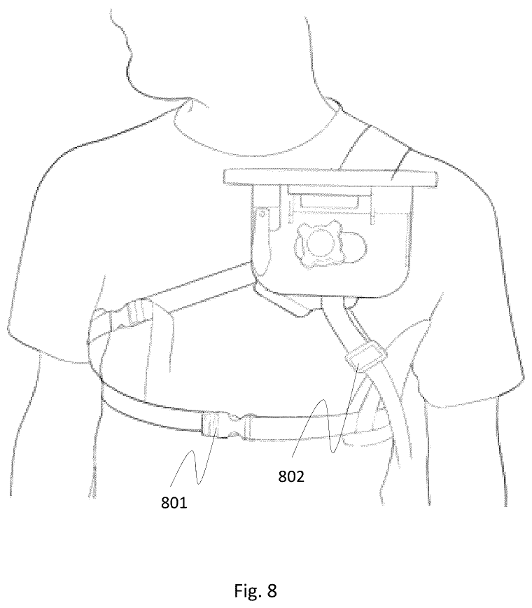

As shown in FIG. 7, the upper plate has a plurality of apertures that allow a cat to maintain its position by extending its claws into one or more of those apertures (701).

As shown in FIG. 8, the harness structure has one or more buckle fixtures, 801, and one or more adjustment structures, 802, which enable quick deployment and adjustment, as well as quick removal of the invention platform from a wearer's shoulder and upper torso.

The upper, outer, and inner plates may be made of any material sufficiently rigid and durable to support a predetermined upper weight limit. As shown in the embodiments, the fixtures that hold the upper plate to outer plate, and outer plate to inner plate, are shown as threaded bolt-and-nut structures. These are exemplary and may be implemented using other fixture structures. The strap that joins the front and rear upper plates is described as hook-and-loop strapping. This is exemplary and may be implemented using other, adjustable-length, strapping materials.

The harness may be made of fabric, leather, vinyl or other similar materials so long as when adjusted, the adjustments are preserved until readjusted.

What is claimed is:

1. A shoulder-mounted platform system for shoulder cats comprising:
two upper plates;
two outer plates;
two inner plates;
an adjustable strapping structure; and
an adjustable harness structure.

2. A system as in claim 1 further comprising:
two fixture structures wherein:
one fixture structure is operative to join one of the upper plates to one of the outer plates; and
another fixture is operative to join one the outer plates to one of the inner plates.

3. A system as in claim 2 wherein:
each of the two outer plates comprises two, hinged, portions operative to allow one hinged portion to be affixed to one of the inner plates in a vertical orientation and the other hinged portion to be rotated in a vertical plane.

4. A system in claim 3 further comprising:
a clamping fixture operative to allow rotation of the other hinged portion and then lock the position in place.

5. A system as in claim 2 wherein:
each of the upper plates has an elongated aperture.

6. A system as in claim 2 wherein:
each of the outer plates has an elongated aperture.

7. A system as in claim 1 wherein:
each of the upper plates has a plurality of apertures.
